(19) United States
(12) Patent Application Publication
(10) Pub. No.: US 2017/0024993 A1
(43) Pub. Date: Jan. 26, 2017

(54) Internet of things based Deadbolt lock latch strike location smart sensor

(71) Applicant: JULIA LEE, Plainsboro, NJ (US)

(72) Inventor: JULIA LEE, Plainsboro, NJ (US)

(21) Appl. No.: 14/804,146

(22) Filed: Jul. 20, 2015

(51) Int. Cl. G08B 21/18; H04L 29/08

(52) U.S. Cl. CPC G08B 21/18; H04L 67/12; H04L 67/10

(57) ABSTRACT

This invention is about Internet of things based Deadbolt lock latch strike location sensor, it can be installed and embedded in a variety of residential and commercial Doorframes, intelligent positioning and sensing any Deadbolt lock latch strike position. The location information is processed by the microprocessor, via wireless communication, transmitted to the Internet of things gateway or smart phones, to judge and track the residential and commercial doors are closed or lock is locked;

### BACKGROUND OF THE INVENTION

Field of the Invention

The present invention relates to Internet of things, wireless sensor network, smart door lock.

Description of the Related Art

The Internet of things, also known as the Internet of objects, refers to the networked interconnection of everyday objects It is described as a self-configuring wireless network of sensors whose purpose would be to interconnect all things. The concept is attributed to the former Auto-ID Center, founded in 1999, based at the time at the Massachusetts Institute of Technology (MIT);

ZigBee is a low-cost, low-power, wireless mesh networking standard. First, the low cost allows the technology to be widely deployed in wireless control and monitoring applications. Second, the low power-usage allows longer life with smaller batteries. Third, the mesh networking provides high reliability and more extensive range. There are three different types of ZigBee devices: ZigBee coordinator (ZC), ZigBee Router (ZR), ZigBee End Device (ZED): Zigbee net allows the ZED node to be asleep a significant amount of the time thereby giving long battery life. ZigBee devices are required to conform to the IEEE 802.15.4-2003 Low-Rate Wireless Personal Area Network (WPAN) standard. The standard specifies the lower protocol layers—the physical layer (PHY), and the media access control (MAC) portion of the data link layer (DLL). This standard specifies operation in the unlicensed 2.4 GHz (worldwide), 915 MHz (Americas) and 868 MHz (Europe) ISM bands. In the 2.4 GHz band there are 16 ZigBee channels, with each channel requiring 5 MHz of bandwidth. The center frequency for each channel can be calculated as, F_{c}=(2405+5* (ch-11)) MHz, where ch=11, 12 . . . 26; Zigbee protocols build on recent algorithmic research (Ad-hoc On-demand Distance Vector) to automatically construct a low-speed ad-hoc network of nodes. In most large network instances, the network will be a cluster of clusters. It can also form a mesh or a single cluster. The current profiles derived from the ZigBee protocols support beacon and non-beacon enabled networks.

Internet of things gateway (Hub) is a one-stop solution for unifying your connected gadgets and controlling them from one simple app, instead of many. But not all hubs are created equal; different hubs support different connectivity protocols, so it's important to look for a hub that supports the devices you use. Bluetooth LE, WIFI, Z-Wave, and ZigBee are all popular ways to connect.

Bluetooth is a proprietary open wireless technology standard for exchanging data over short distances (using short wavelength radio transmissions) from fixed and mobile devices, creating personal area networks (PANs) with high levels of security. Created by telecoms vendor Ericsson in 1994; Bluetooth uses a radio technology called frequency-hopping spread spectrum, which chops up the data being sent and transmits chunks of it on up to 79 bands (1 MHz each) in the range 2402-2480 MHz's This range is in the globally unlicensed Industrial, Scientific and Medical (ISM) 2.4 GHz short-range radio frequency band. Bluetooth is defined as a layer protocol architecture consisting of core protocols, cable replacement protocols, telephony control protocols, and adopted protocols. Mandatory protocols for all Bluetooth stacks are: LMP, L2CAP and SDP. Additionally, these protocols are almost universally supported: HCI and RFCOMM; Bluetooth low energy is an alternative to the Bluetooth standard that was introduced in Bluetooth v4.0, and is aimed at very low power applications running off a coin cell. It allows two types of implementation, dual-mode and single-mode. In a dual-mode implementation, Bluetooth low energy functionality is integrated into an existing Classic Bluetooth controller.

Smart door locks are arguably one of the nicest of smart home comforts. They can automatically detect your presence via the Bluetooth connection in your smartphone (or a Bluetooth key fob) and unlock your front door for you. They let you send electronic keys to your friends that work only during times that you specify.

IEEE 802.11 is a set of standards carrying out wireless local area network (WLAN) computer communication in the 2.4, 3.6 and 5 GHz frequency bands. They are created and maintained by the IEEE LAN/MAN Standards Committee (IEEE 802). The base current version of the standard is IEEE 802.11-2007. IEEE802.11b and IEEE802.11g use the 2.4 GHz ISM band, operating in the United States under Part 15 of the US Federal Communications Commission Rules and Regulations;

IEEE 802.15.4-2006 is a standard which specifies the physical layer and media access control for low-rate wireless personal area networks (LR-WPANs). It is maintained by the IEEE 802.15 working group.

Infrared emitter, or IR emitter, is a source of light energy in the infrared spectrum. It is a light emitting diode (LED) that is used in order to transmit infrared signals from a remote control. In general, the more they are in quantity and the better the emitters are, the stronger and wider the resulting signal is. A remote with strong emitters can often be used without directly pointing at the desired device. Infrared emitters are also partly responsible for limits on the range of frequencies that can be controlled. An IR emitter generates infrared light that transmits information and commands from one device to another. Typically one device receives the signal then passes the infrared (IR) signal through the emitter to another device.

IR detectors (IR receiver) are little microchips with a photocell that are tuned to listen to infrared light. They are almost always used for remote control detection and more.

Proximity sensors detect the presence of objects without physical contact. Since 1983 Fargo Controls' proximity sensors have been of the highest quality, durability & repeatability to meet today's tough industrial requirements.

Positioning Contact Switches no need intermediate actuators by the measuring element of the switch customized for the detected object.

### SUMMARY OF THE INVENTION

Internet of Things applications require real-time positioning of Deadbolt lock latch strike position, especially the smart lock. This patent by installing the smart sensor in Doorframe, the battery-powered sensors to achieve the precise location of the query sensing and data processing, and by wireless means (including Bluetooth, WIFI and other wireless communication standards and protocols), send the information to the Internet of things gateway and smart phones and other mobile devices, cloud computing server, users can use this information to know whether residential and commercial door closed/open and lock is turned on/off;

### BRIEF DESCRIPTION THE DRAWINGS

FIG. 1 is a block diagram of a Deadbolt locks latch strike location sensor installed in Doorframe;

FIG. 2 is a block diagram of the sensors embedded microprocessors and micro-power wireless transceiver;

FIG. 3 is a block diagram of the smart location sensor. The smart sensor receives and processes information, and by wireless means (including Bluetooth, WIFI and other wireless communication standards and protocols), send the information to the Internet of things gateway and smart phones and other mobile devices, cloud computing server;

FIG. 4 is a block diagram of a IR transmitting and receiving sensors

FIG. 5 is a block diagram of a proximity Sensors;

FIG. 6 is a block diagram of a positioning Contact Switch sensor;

### DETAILED DESCRIPTION OF THE PREFERRED EMBODIMENT

A lock installed on a residential or commercial door, when the door closed and locked, the lock bolt is inserted into the door frame;

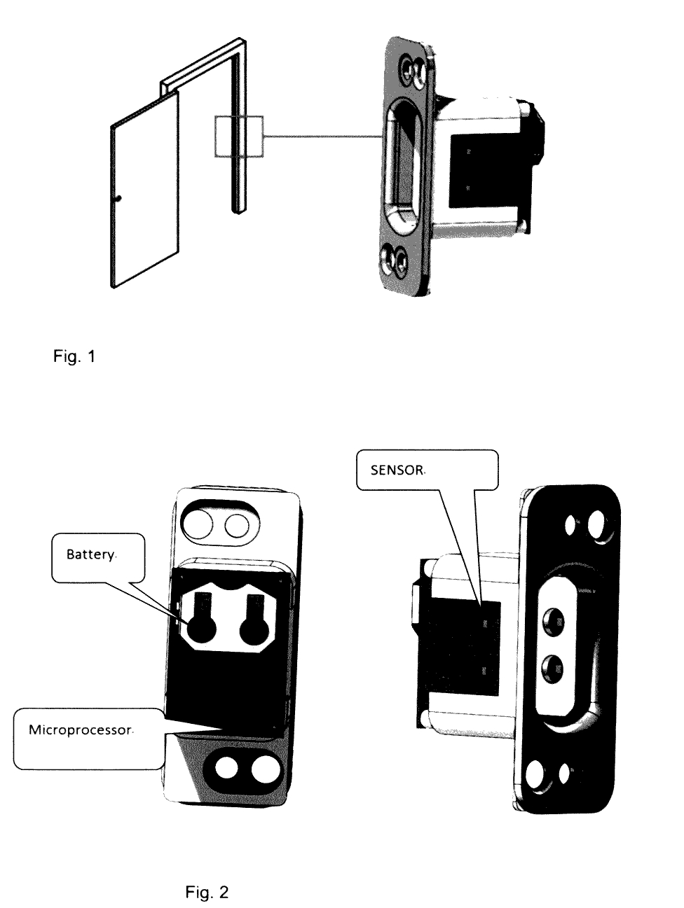

A Deadbolt locks latch strike location sensor installed in Doorframe see FIG. 1;

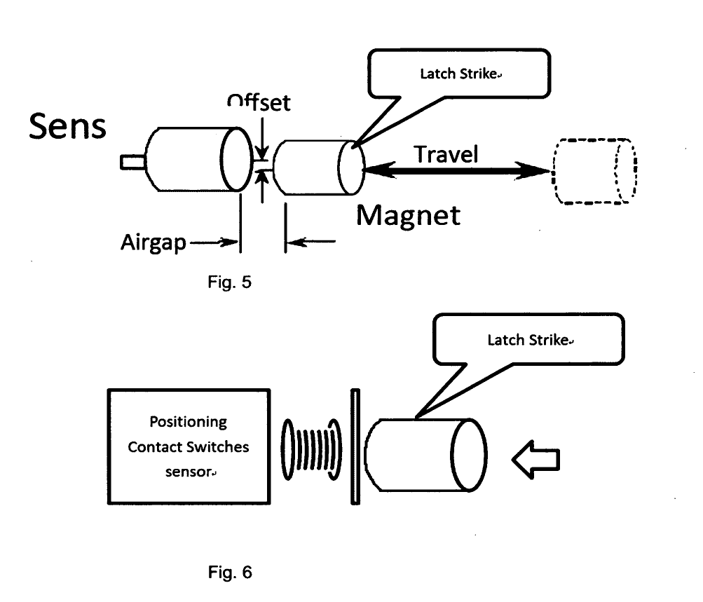

A Internet of things based Deadbolt lock latch strike location detecting sensor comprising of: an integrated 1 or more pairs of IR transmitting and receiving sensors, Proximity Sensors, contact switches and other physical position sensors that are installed in any door frame inside, can accurately sense and find Deadbolt lock latch strike exact location. See FIG. 4, FIG. 5, FIG. 6;

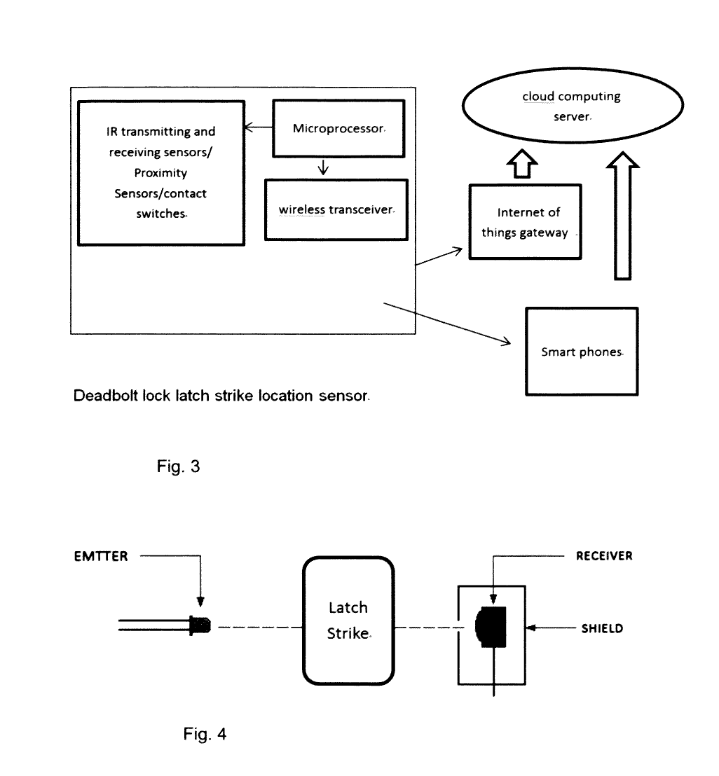

The sensors embedded microprocessors and micro-power wireless transceiver, these components receive and process information, and by wireless means (including Bluetooth, WIFI and other wireless communication standards and protocols), send the information to the Internet of things gateway and smart phones and other mobile devices, cloud computing server. Users can use this information to know whether residential and commercial door closed/open and lock is turned on/off, see FIG. 2, FIG. 3;

What is claimed is:

1. A Internet of things based Deadbolt lock latch strike location detecting sensor comprising of:
A sensing unit comprising of one or more pairs of IR transmitting and receiving sensors, Proximity Sensors, contact switches and other physical position sensors, the sensing unit is installed inside a door frame, the sensing unit accurately sense and find Deadbolt lock latch strike the exact location;
The sensing unit comprising of embedded microprocessors and a micro-power wireless transceiver, wherein the embedded microprocessors and the micro-power wireless transceiver comprising of a battery-powered sensor, wherein battery-powered sensor receive and process information wirelessly;
Send the information to one of an Internet of things gateway, smart phones, cloud computing server and other mobile devices, the information indicates whether a residential or commercial door is closed or open and lock is turned on or off.
